(19) United States
(12) Patent Application Publication
(10) Pub. No.: US 2008/0195586 A1
(43) Pub. Date: Aug. 14, 2008

(54) Ranking search results based on human resources data

(75) Inventors: Arne Karl Arnold, Heidelberg (DE); Uwe Kindsvogel, Ubstadt-Weiher (DE)

Correspondence Address: MINTZ, LEVIN, COHN, FERRIS, GLOVSKY & POPEO, P.C.;ATTN: PATENT INTAKE CUSTOMER NO. 64280, ONE FINANCIAL CENTER, BOSTON, MA, 02111, US

(73) Assignee: SAP AG

(21) Appl. No.: 11/704,584

(22) Filed: Feb. 9, 2007

(51) Int. Cl. G06F 17/30

(52) U.S. Cl. 707/3; 707/E17.014

(57) ABSTRACT

Methods and apparatus, including computer program products, are provided for ranking search results based on context information, such as organization information obtainable from human resources information. In one aspect, there is provided a computer-implemented method. The method may include receiving a keyword used to perform a search for one or more documents. The context information representative of a relationship between a user performing the search and the one or more documents being searched may be determined. The relationship between the user and the document may be determined by the ternary relationship between the user, the document, and the document's author. The relationship may be representative of an organizational relationship between the user and the one or more documents being searched. The results of the search may be provided based on the determined context information. Related apparatus, systems, methods, and articles are also described.

### FIELD

The present disclosure generally relates to data processing. More particularly, the present disclosure relates to performing searches using context information representative of a relationship between the user performing a search and a document being searched.

### BACKGROUND

The amount of searchable data on the Internet is increasing on a daily basis. Using a search engine or tool to find the right information during a search has become increasingly difficult due to large amounts of searchable data now available electronically. As a consequence, users are becoming inundated with search results, many of which are not relevant to the user's search. One way to manage search results is to use direct, bidirectional relationships between a user and the results of the search. For example, search results may be limited by the location of the user and the location of the document being searched (e.g., limiting search results to documents having the same country as the country of the user performing the search). This approach, however, may not be effective since the actual location of the user and the actual location of the document may not be available or accurate. Alternatively, a user may avoid being inundated by a large quantity of search results by initiating a deep, structured search including many structured search terms. This approach, however, is burdensome to the user performing the search and does not provide any ranking mechanism for the search results. Providing mechanisms to enable meaningful search results continues to be a challenge for developers.

### SUMMARY

The subject matter disclosed herein provides methods and apparatus, including computer program products, for performing searches using context information representative of a relationship between the user performing a search and a document being searched. The context information may be used to compute the relevancy ranking of the documents identified by any search results.

In one aspect, there is provided a computer-implemented method. The method may include receiving a keyword to perform a search for one or more documents. The context information representative of a relationship between a user performing the search and the one or more documents being searched may be determined. The relationship may be representative of an organizational relationship between the user and the one or more documents. The results of the search may be provided based on the determined context information.

Variations may include one or more of the following features. The documents may be implemented as data stored in a file system (e.g., unstructured data, such as Word™ and PDF documents) and structured data stored in a relational database (e.g., business objects). The relationships between the user performing the search and the authors of the documents may be used to rank as well as limit the search. Moreover, the relationships may be defined by the organizational relationship between the user and the authors. The relationships may be determined based on context information representative the user and the authors that created the documents included in the one or more results. The context information may be determined as a distance metric representative of the organizational relationship between the user performing the search and the documents being searched. The distance metric may be determined from a first organization corresponding to the user performing the search and a second organization corresponding to at least one of the documents being searched. The distance metric may be determined by determining a number of hops from the first organization to the second organization. The results may be ranked based on the determined context information. The search may be limited based on the determined context information.

The subject matter described herein may be implemented to realize the advantage of providing to a user relevant search results by using context information associated with the user performing the search and the documents being searched. The context information may be used for ranking, e.g., sorting the result items (e.g., documents) to provide an indication of their relevance to the user. For example, the user's relationship to the authors of the resulting items (e.g., documents identified by the search) may be used to determine the relevance of the resulting items.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

In the drawings,

FIG. 1 depicts a block diagram of a system implementing searches using context information representative of a relationship between the user performing a search and the documents being searched;

FIG. 2 depicts a process flowchart for using context information to provide search results;

FIG. 3A depicts an example organization chart, from which context information may be determined;

FIG. 3B depicts an example of a ternary search;

FIG. 3C depicts a use case for performing a search using context information;

FIG. 4 depicts a process flowchart for searching using context information to provide ranked search results; and

FIG. 5 depicts a process flowchart for searching using context information to provide search results limited based on the context information.

Like labels are used to refer to same or similar items in the drawings.

### DETAILED DESCRIPTION

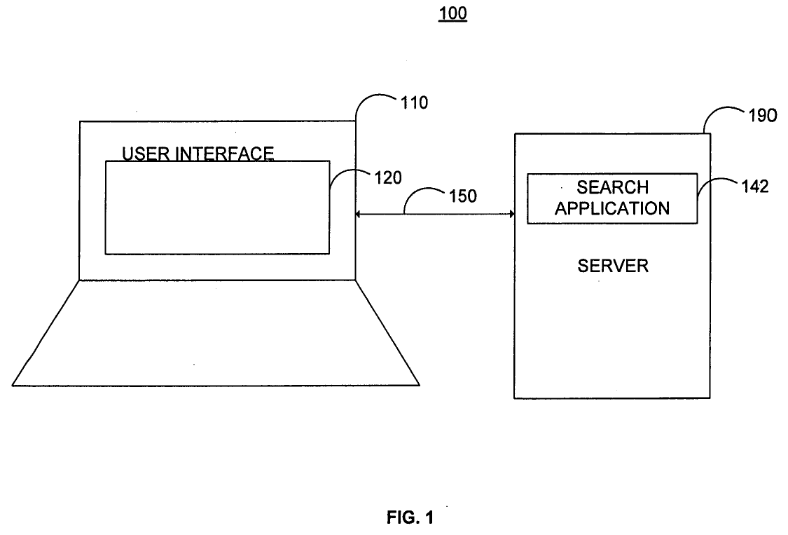

FIG. 1 depicts a system 100 environment capable of providing search results based on context information. The context information may be any information enabling the determination of a relationship between the user performing the search and the documents being searched. In one implementation, the context information may include human resource data indicative of a user's position within an organization. For example, human resource data may be used to identify the department of the user performing the search and to identify the departments of the authors of the documents being searched. The organizational relationship (e.g., the department of the user performing the search and the authors of the documents being searched) provides context information for the search results, so that the search results are more likely to be relevant to the user performing the search since the closer the organizational relationship between the user performing the search and the author of the document, the more,likely the document is relevant to the user. For example, if the user searches for documents containing “2007 Budget,” documents authored by (as well as edited by or stored by) people in the user's department are more likely to be relevant to the user's search when compared to documents authored by people in other departments or organizations.

System 100 includes a processor, such as a computer 110, coupled through communication link 150 (e.g., the Internet or an intranet) to another processor, such as server 190. The computer 110 may further include a user interface 120 for interacting with server 190 and a search application 142. The search application 142 may perform one or more of the following functions: determining context information corresponding to a user performing a search; determining context information corresponding to the documents being searched; receiving a keyword used to perform a search for one or more documents; searching indexes of documents to perform the search; providing search results based on the determined context information; ranking search results based on the determined context information; searching based on the determined context information and a keyword; determining the context information as a distance metric representative of the relationship between the user performing the search and the documents being searched; and determining the distance metric using human resources information, such as an employee directory or an organizational structure. In some implementations, search application 142 may be implemented as a search engine.

Although context information (including information representative of the organizational relationship between a user and the documents) may be obtained from human resources data including the position of the user performing the search and the position of others associated with documents being searched (e.g., an author of the document, a creator of a document, a modifier of a document, an owner of a document, a custodian of a document, and the like), the organizational relationship information may be obtained from sources other than human resource data and may take other forms. For example, the organizational relationship information may be obtained from an address book, an employee directory, keywords listed in an employee directory, and any other information that may be used to determine a relationship between the user (i.e., the searcher) and the document (e.g., the author, creator, owner, editor, etc).

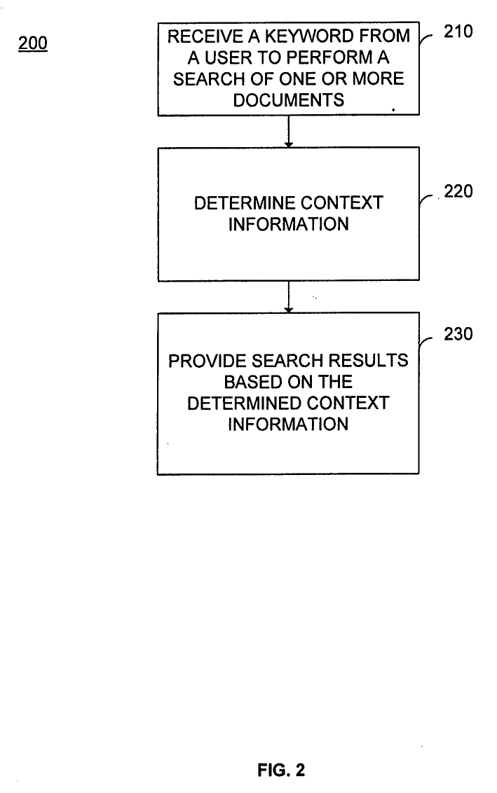

FIG. 2 depicts a process for using context information when performing searches. A user of user interface 120 may provide a keyword to perform a search at server 190 and search application 142. At 210, server 190 receives the keyword to enable search application 142 to perform the search of one or more documents. The server 190 may also receive information identifying the user of user interface 120. For example, the server 190 may receive a login identifier for the user of user interface 120.

At 220, the search application 142 determines context information for the user of user interface 120. For example, search application 142 may determine the user's position within an organization based on the user's login identifier. The search application 142 may also determine context information associated with documents being searched. For example, the search application 142 may determine the positions within an organization of one or more authors of the documents being searched. In this example, the context information is in the form of an organizational relationship between the user's position and the authors' position with the organization.

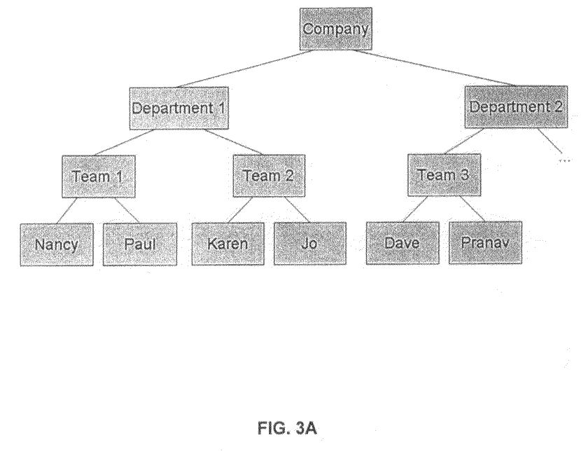

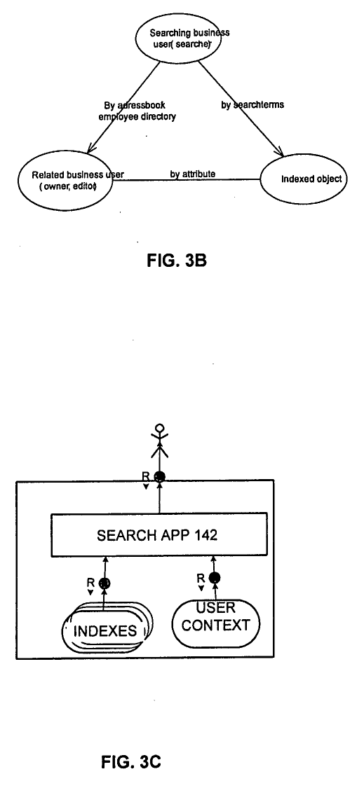

In some implementations, determining context information may also include search application 142 determining a so-called “distance metric” between the user performing the search and the document being searched. FIG. 3A depicts an example of an organizational structure which may be determined from human resources data. If the user performing the search is “Nancy” and one of the documents being searched is authored by “Paul,” the context information would indicate a distance metric of 2. One the other hand, if the document is authored by “Pranav,” the distance metric would be greater (e.g., 6) since the user and document owner are in different departments. In this example, the distance metric is determined based on the number of hops from one user to another, although other approaches may be used to determine the distance metric and the closeness of the relationship.

In some implementations, keywords from an employee directory are used as context information to determine a relationship between a user performing the search and the author of the document(s) being searched. When that is the case, the correspondence of keywords in an employee directory for the user and author may be used. For example, if Nancy (FIG. 3A) has provided the keywords “portal”, “java”, and “developer” as entries in her employee directory, the application 142 may rank higher documents from authors having those three keywords listed, when compared to documents having authors with none, one, or two of those keywords. Continuing the example, documents authored by Paul (FIG. 3), who only includes the keyword “java” may be ranked higher than a documents from Dave with keywords “HR” and “field services.” In this example, the distance metric from Nancy to Paul is 1 (since one keyword matches), and the distance metric from Nancy to Dave is 0 (since none of the keywords match). The matching of keywords thus suggests that the user and authors of the document work on similar topics. In short, the more keywords that match between the user and the author, the closer their relationship might be. The closer the relationship, the higher the author's documents is ranked within the search results.

In some implementations, an address book is used as context information to determine a relationship between a user performing the search and the author of the document(s) being searched. When that is the case, several attributes may be used to determine a relationship between an author of the document and the user performing the search. For example, the relationship may be determined from geographical information including attributes like “office location” and/or “office number.” The relationship information may also be determined from organizational information in the address book including one or more of the following: the name or phone number of a secretary (or supervisor), an in-house mail address, a cost center, and an organizational identifier. Moreover, the number of corresponding attributes may be used as a distance metric. For example, the more attributes from the address box that match between the user and the author, the closer the relationship is in terms of distance. The closer the relationship, the higher the corresponding document is ranked when compared to other documents having fewer matching attributes. In addition, attributes may be weighted, so that some attributes are considered more than others are. For example, if a user and the author of a document have the same attribute “secretary” (e.g., both sharing the same secretary), that document would be ranked higher when compared to similar documents without a searching user and document author having the same secretary attribute. Alternatively, using weighted attributes, two documents sharing the same secretary between user and author may be ranked higher than documents from people sharing the same building by weighing the attribute “secretary” twice as much as the attribute “building”. In this example, the attribute secretary is more relevant in ranking and finding documents that merely working in the same office building.

Referring again to FIG. 2, at 230, the search application 142 may then provide search results for the keyword based on the determined relationship between the user and the one or more documents being searched. In some implementations, the distance determined at 220 may be used to rank search results. For example, if search application 142 searches documents and identifies 10 results, search application 142 may use the distance metric determined in 220 to rank the search results. Returning to the above example, a document from Paul with a distance of 2 may be ranked higher than a document from Pranav with a distance of 6. Ranking using context information representative of the relationship between the user and the document is more likely to provide more meaningful search results to the user of user interface 120.

In some implementations, the search application 142 may limit the search results by using context information as a search term to limit the search results. Specifically, the search application 142 may search using the keyword (provided by the user) and search for other context information. The context information may be in the form of metadata and may be categorized based on attributes. For example, a document may include metadata categorized as attributes, such as filename, file location, created by, modified by, owned by, authored by, category, keyword(s), and the like. The search may include the keyword as well as context information. Returning to the above example, the search terms may include “Budget 2007” and “authored by Paul.” The context information in this example limits the user's search of “Budget 2007” to documents where “Paul” is an author, so that the search results are more likely to be relevant to the user of user interface 120. The usage of metadata including context information may be done explicitly by the searching user (as described in the previous example), but usage of the metadata may also be done implicitly by search application 142. In the implicit case, the search application 142 may determine a list of people having the same attribute (e.g., manager, organizational identifier, such as department) and then add the list of people to the search query. For example, if Nancy is searching for documents including the keyword “Budget 2007,” the search application 142 may automatically search for “Budget 2007” AND “author=Paul OR author=Nancy OR author=Karen OR author=Jo” to limit the number of search results to documents from authors in “Department 1” (FIG. 3).

Although the above description refers to searching “documents,” searching documents may also include searching indexes of documents, such as indexes created by search applications. Moreover, the documents may include any item including files, web pages, objects, images, audio, word processing documents, HTML pages, code, and structured data (e.g., business objects stored in a relational database). A business object (BO) represents structured data and/or methods. The term business object (BO) represents an object, such as a data structure including data and operations, of significance to a business. Examples of business objects include a purchase order, a sales order, a flight reservation, a shipping order, customer information, employee information, material master, business partner information, invoice information, business objects like business partner in an ERP system, and the like.

Referring again to FIG. 1, the user interface 120 may be implemented as any interface that enables a user to interact with an application or program, such as search application 142, through communication link 150. The user interface 120 may be implemented as a browser, such as Netscape Navigator or the like, or any other type of graphical user interface. In some implementations, SAP Web Dynpro (commercially available from SAP AG, Walldorf, Germany) may be used as a model-based development environment for generating user interface 120, although other development environments may be used.

Communication link 150 may be any type of communications mechanism and may include, alone or in any suitable combination, the Internet, a telephony-based network, a local area network (LAN), a wide area network (WAN), a dedicated intranet, wireless LAN, an intranet, a wireless network, a bus, or any other communication mechanisms. Further, any suitable combination of wired and/or wireless components and systems may provide communication link 150. Moreover, communication link 150 may be embodied using bidirectional, unidirectional, or dedicated communication links. Communication link 150 may also implement standard transmission protocols, such as Transmission Control Protocol/Internet Protocol (TCP/IP), Hyper Text Transfer Protocol (HTTP), SOAP, RPC, or other protocols.

Server system 190 may include one or more processors, such as computers, to interface with other computers, such as computer 110, and/or programs, such as user interface 120. The search application 142 may be implemented as a program, group of programs, and/or component, i.e., a small binary object (e.g., an applet) or program that performs a specific function and is designed in such a way to easily operate with other components and programs.

In some implementations, the search application 142 may enable and disable the use of context information during a search. Moreover, although FIG. 1 depicts search application 142 at server 190, search application 142 may be located at other locations and in multiple locations. For example, the search application 142 may be a component, such as a plug-in, of user interface 120 or of a search engine, examples of which include a desktop search engine.

FIG. 3B depicts the process flow of FIG. 2 as a ternary search using keywords (e.g., search terms) as well as context information representative of the searcher (i.e., the user performing the search) and representative of attributes of the documents (e.g., document creators, authors, editors, and the like). The index of documents is searched based on the keyword provided by the user and the context information organized by attribute.

FIG. 3C depicts a use case for the process flow of FIG. 3B. The use case shows a user of a search application 142 searching indexes of documents using user context information (i.e., context information).

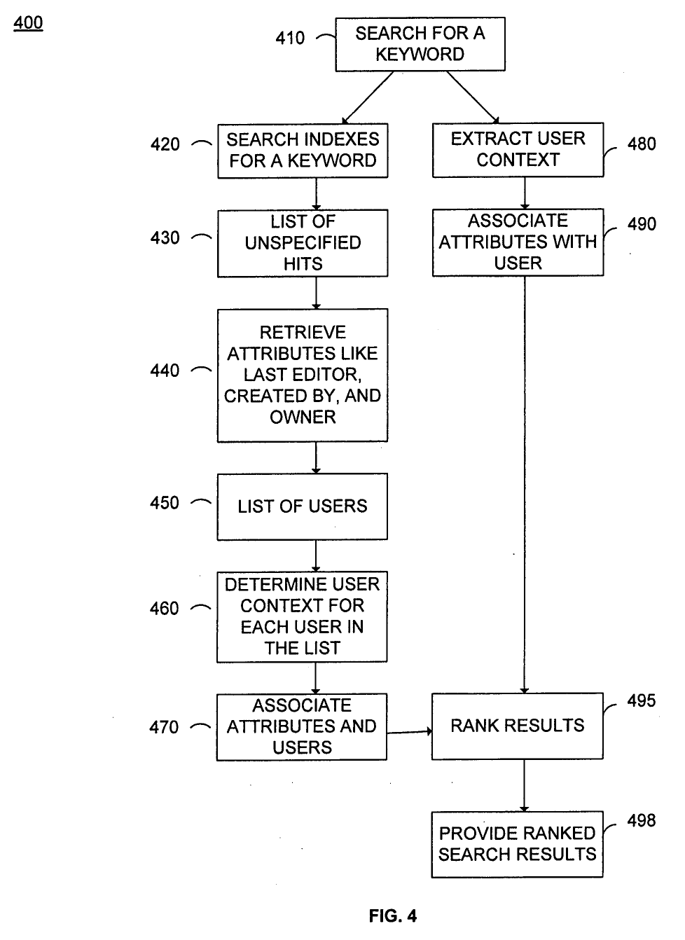

FIG. 4 is a diagram depicting a ranking of search results based on context information. At 410, a user of user interface 120 searches documents using a keyword (e.g., a search term). For example, the search may be for all documents including the term “Project Schedule.” At 420, search application 142 receives the keyword and searches one or more indexes for the keyword. An index may refer to a file storing information describing other documents to facilitate document retrieval during a search. The index may list keywords of documents and their locations.

At 430, the search application 142 provides the results (e.g., unspecified hits) of the search, such as any documents including the keyword being searched. The results may also include a description of each document, metadata associated with each document, and a location of each document.

At 440, the search application 142 may retrieve one or more attributes for the results of 430. For example, the documents may each include metadata. The metadata may include context information organized into attributes, such as an owner of a document, the last editor of a document, a creator of a document, customer information, supplier information, competitor information, department information, organizational information, a cost center, a project assignment, a job function, a job, a role, an employee type, a position in an organization, and/or self-assigned keywords.

At 450, the search application 142 may determine users associated with the search results. Table 1 below shows examples of search results (e.g., Document 1-Document 4) and users associated with the documents.

TABLE 1

| | | | Owned |
|---|---|---|---|
| | Created by | Last Edited By | (Stored) by |
| www.sap.com/Document 1 | Nancy | Nancy | Nancy |
| www.sap.com/Document 2 | Paul | Nancy | Karen |
| www.sap.com/Document 3 | Karen | Karen | Jo |
| www.sap.com/Document 4 | Pranav | Pranav | Dave |

At 460, the search application 142 may then determine context information for each of the users associated with the documents. For example, the search application 142 may utilize context information, such as human resources information, address book information, employee directory, and organizational information, to determine context information for each of the users associated with the documents. In the example of Table 1, the search application 142 may determine the position in an organization of each user.

At 470, the search application 142 may then associated the context information with the attributes. Table 2 below depicts such an association.

TABLE 2

| | Created by | Context Information |
|---|---|---|
| www.sap.com/Document 1 | Nancy | Department 1/Team 1 |
| www.sap.com/Document 2 | Paul | Department 1/Team 1 |
| www.sap.com/Document 3 | Karen | Department 1/Team 2 |
| www.sap.com/Document 4 | Pranav | Department 2/Team 3 |

At 480, the search application 142 may determine context information, such as human resources information, address book information, employee directory, and organizational information, for the user performing the search. For example, if the user performing the search is Nancy, her position in the organization chart of FIG. 3A may be used as context information.

At 490, search application 142 may then associate the context information of the user performing the search with attributes. In some implementations, the attributes for the user performing the search are the same type of attributes as the ones determined at 470. For example, if the attribute “created by” were used at 470, the same attribute would be used at 490. In this example, the attribute to be determined would be the department, corresponding to Tables 1 and 2. In this example, Tables 1 and 2 represents a so-called “positive/negative decision” on the department of the searching user and the author of the documents, as there is a relation between the departments preconfigured in the address book. In this case, the distance metric may be determined using the hop method defined above or as a binary decision (e.g., a distance of “1” if user and author are in the same department, otherwise a “0”). Alternatively, the manager (or department) of the searching user and of the document authors may be determined to enable a distance metric to be calculated by counting the number of hops along the organization chart.

At 495, the search application 142 ranks the results of the search by determining the relationship between the context information of the user performing the search and the context information associated with the documents. The search application 142 may determined a distance metric to determine the relationship between the context information of the user performing the search and the context information associated with the attributes of a document. For example, if Nancy is the person performing the search and the attribute is “department” and/or “created by,” a distance measurement from Nancy to the documents may be as follows: 0 (Document 1), 2 (Document 2), 4 (Document 3), and 6 (Document 4). The documents would, in this example, be ranked as follows: Document 1, Document 2, Document 3, and Document 4. In some implementations, the ranking at 495 may be performed by first computing the distance metric between a user and an author, and then ranking the results.

In some implementations, multiple attributes are used (e.g., created by and last edited by). When that is the case, the distance metric for each attribute is determined and then the distance metrics are combined. For example, a distance metric is determined for created by and another distance metric is determined for last edited by; the two distance metrics are then combined to provide an overall distance metric for ranking search results.

At 498, the search application 142 provides the ranked search results to user interface 120, so the user may view the results of the search.

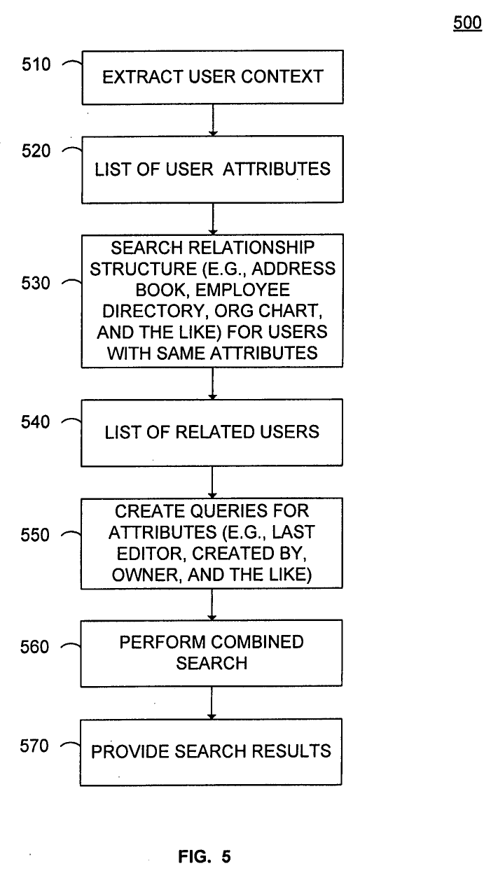

FIG. 5 depicts search application 142 performing a search using the keyword provided by the user and other attributes associated with the documents to limit the search to only those documents having a relationship to the searcher (as determined from the context information).

At 510, the search application 142 may determine context information for a user performing a search by extracting the context information from, for example, human resources information, address book information, employee directory, and/or organizational information. To extract such information, the user performing the search may be required to first login to clearly authenticate and identify the user. The user's identity (e.g. the identity (ID) from a logon ticket) may be used to retrieve further information for that user, such as information from a human resources (HR) system (e.g., employee information database) or an employee directory. The HR system may include a data set for each employee. This data set may contain the following attributes: organizational information (e.g., unit, department, group, etc.), where the employee works in (e.g., office location), and the manager to which the employee reports, and a cost center to which the employee expenses are booked. For example, the HR system may be configured to include the function “getEmployeeData” for an employee. When the user performing the search is an employee, information associated with the aforementioned attributes may be retrieved using that function. In the example of Table 2 above, the search application 142 may use the retrieved information to determine the position of the user in an organization, such as the organization chart of FIG. 3A.

At 520, the search application 142 may determine one or more attributes for the user. For example, the user may have one or more of the following attributes: a keyword, a manager, a department, a team, an organization, and the like. Those attributes may be included on a list of attributes.

At 530, the search application 142 searches for other users with similar attributes. For example, search application 142 may search address books, employee directories, organizational information, and the like for other users with similar attributes. Referring to the above example, if the user is Nancy (FIG. 3A) of Department 1, all employees in Department 1 may be determined to be users with similar attributes. At 540, the search application 142 lists these users with similar attributes.

At 550, the search application 142 creates a query including the keyword and additional query terms including attributes. For example, search application 142 combines the search term with the list of users that may have “edited”, “authored” or “stored” the document. At 560, the search application 142 performs a keyword search, which is limited to include attributes. For example, if Nancy is performing a search for “Project 1 Schedule,” the search application 142 may create a query that when performed limits the search to results including at least one of the following attributes: “Created by Nancy,” “Created by Paul,” “Created by Karen,” or “Created by Joe.” In the previous example, Nancy's search for “Project 1 Schedule” is limited based on context information, namely documents created by people in her department.

At 570, search application 142 provides the search results to user interface 120, so that a user may view the results.

Although FIG. 1 is described with respect to a client-server architecture, system 100 can also use any other architecture or framework. Moreover, although FIG. 1 shows a single computer 110 and a single server system 190, a plurality of computers and servers may be used, and those computers and servers may be distributed among multiple locations. Furthermore, when the above description refers to a “user,” the user may be a person or a processor, such as a computer or program.

Moreover, although the above describes the context information as an organizational relationship corresponding to the departments associated with the user performing the search and others associated with the documents being searched, other relationships may be used as well. For example, an organizational relationship may also be implemented that uses a relationship between the user performing the search and a customer, a supplier, or other entities outside the organization.

In some implementations, a user may provide a user identifier and/or a password to login to a computer providing access to one or more documents being searched. Those documents may be copied from their primary storage location to a storage location associated with search application 142 (configured as a search engine). In addition, the context information including organizational information associated with the user and the authors of the documents being searched may be stored in a relational database. The stored context information (i.e., stored in the relational database) may then be copied to the storage location associated with application 142. When a user performs a search using the search application 142, it accesses the associated storage location to search the documents and use the context information.

As used herein, an author of a document includes a creator of the document, a modifier of the document, an owner of a document, a custodian of a document, and any other person identified in metadata associated with the document.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed embodiments may be implemented in various environments. Such environments and related applications may be specially constructed for performing the various processes and operations according to the disclosed embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed embodiments, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The foregoing description is intended to illustrate but not to limit the scope of the invention, which is defined by the scope of the appended claims. Other embodiments are within the scope of the following claims.

What is claimed is:

1. A computer-implemented method comprising:
receiving a keyword to perform a search for one or more documents;
determining context information representative of a relationship between a user performing the search and the one or more documents being searched, the relationship representative of an organizational relationship between the user and the one or more documents being searched; and
providing, based on the determined context information, one or more results of the search.

2. The computer-implemented method of claim 1 further comprising:
determining, by a search engine, the context information as a distance metric representative of the organizational relationship between the user performing the search and one or more documents being searched.

3. The computer-implemented method of claim 2, wherein determining the context information as the distance metric further comprises:
determining the distance metric from a first organization corresponding to the user performing the search and a second organization corresponding to at least one of the documents being searched.

4. The computer-implemented method of claim 3 further comprising:
determining, for at least one of the documents being searched, the second organization of an author of at least one of the documents.

5. The computer-implemented method of claim 3 further comprising:
determining the first organization as a department of the user performing the search.

6. The computer-implemented method of claim 3 further comprising:
determining the distance metric by determining a number of hops from the first organization to the second organization.

7. The computer-implemented method of claim 3 further comprising:
determining the distance metric using a first set of attributes associated with the user and a second set of attributes associated with authors of the one or more documents, each match between the first and second set of attributes representative of a distance metric value of one.

8. The computer-implemented method of claim 1 further comprising:
ranking the one or more results based on the determined context information.

9. The computer-implemented method of claim 2 further comprising:
ranking the one or more results based on the distance metric.

10. The computer-implemented method of claim 1 further comprising:
searching based on the determined context information to limit the results of the search.

11. The computer-implemented method of claim 10 further comprising:
search using another keyword determined based on the context information to limit the one or more results.

12. The computer-implemented method of claim 1 further comprising:
implementing the one or more documents to include one or more of the following: data stored in a file system and structured data stored in a relational database.

13. The computer-implemented method of claim 1 further comprising:
using one or more relationships between the user and the authors of the one or more results of the search, the one or more relationships defined by the user's organizational relationship to the authors determined from context information representative of the authors that created the documents identified by the one or more results.

14. The computer-implemented method of claim 1 further comprising:
providing a user identifier to login to a computer including the one or more documents being searched;
copying the one or more documents being searched to a storage location associated with a search engine;
storing context information and representing the relationship in a relational database;
copying the context information to the storage location associated with the search engine; and
sending, to the search engine, a search request including the keyword.

15. A computer-readable medium containing instructions to configure a processor to perform a method, the method comprising:
receiving a keyword to perform a search for one or more documents;
determining context information representative of a relationship between a user performing the search and the one or more documents being searched, the relationship representative of an organizational relationship between the user and the one or more documents being searched; and
providing, based on the determined context information, one or more results of the search, the results provided.

16. The computer-implemented method of claim 15 further comprising:
determining, by a search engine, the context information as a distance metric representative of the organizational relationship between the user performing the search and one or more documents being searched.

17. The computer-readable medium of claim 16, wherein determining the context information as the distance metric further comprises:
determining the distance metric from a first organization corresponding to the user performing the search and a second organization corresponding to at least one of the documents being searched.

18. The computer-readable medium of claim 17 further comprising:
determining, for at least one of the documents being searched, the second organization of an author of at least one of the documents.

19. The computer-readable medium of claim 17 further comprising:
determining the first organization as a department of the user performing the search.

20. A system comprising:
a processor; and
a memory, wherein the processor and the memory are configured to perform a method comprising:
receiving a keyword to perform a search for one or more documents;
determining context information representative of a relationship between a user performing the search and the one or more documents being searched, the relationship representative of an organizational relationship between the user and the one or more documents being searched; and providing, based on the determined context information, one or more results of the search.
